(19) United States
(12) Patent Application Publication
(10) Pub. No.: US 2014/0208736 A1
(43) Pub. Date: Jul. 31, 2014

(54) Force transfer device

(71) Applicant: Marshall Anlauf Thompson, Camarillo, CA (US)

(72) Inventor: Marshall Anlauf Thompson, Camarillo, CA (US)

(21) Appl. No.: 13/815,109

(22) Filed: Jan. 31, 2013

(51) Int. Cl. F03B 17/02

(52) U.S. Cl. CPC F03B 17/02
USPC 60/496

(57) ABSTRACT

A device which utilizes buoyancy and draws all or a majority of the energy required to make it function from gravity and is able to convert more of that energy into usable force than is required to operate the device

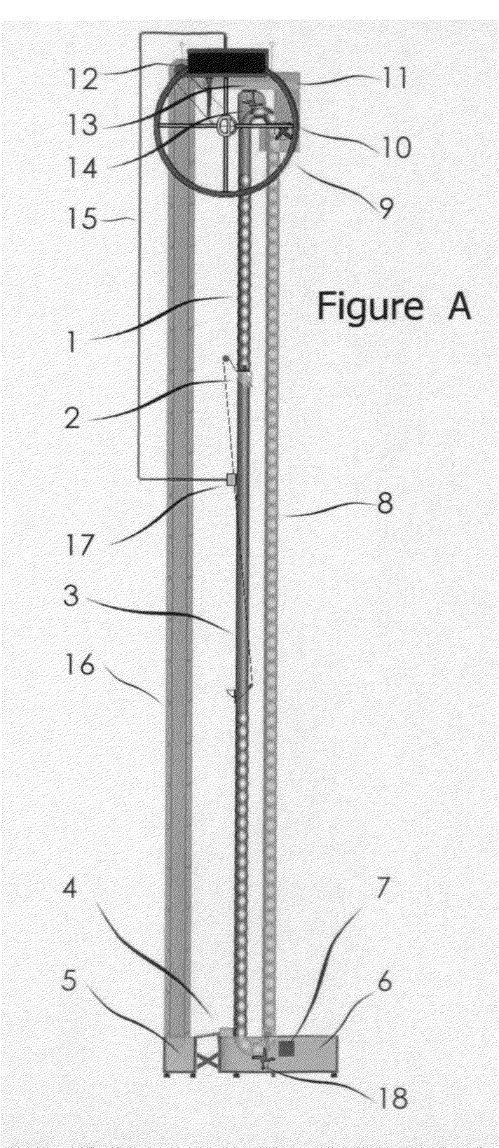

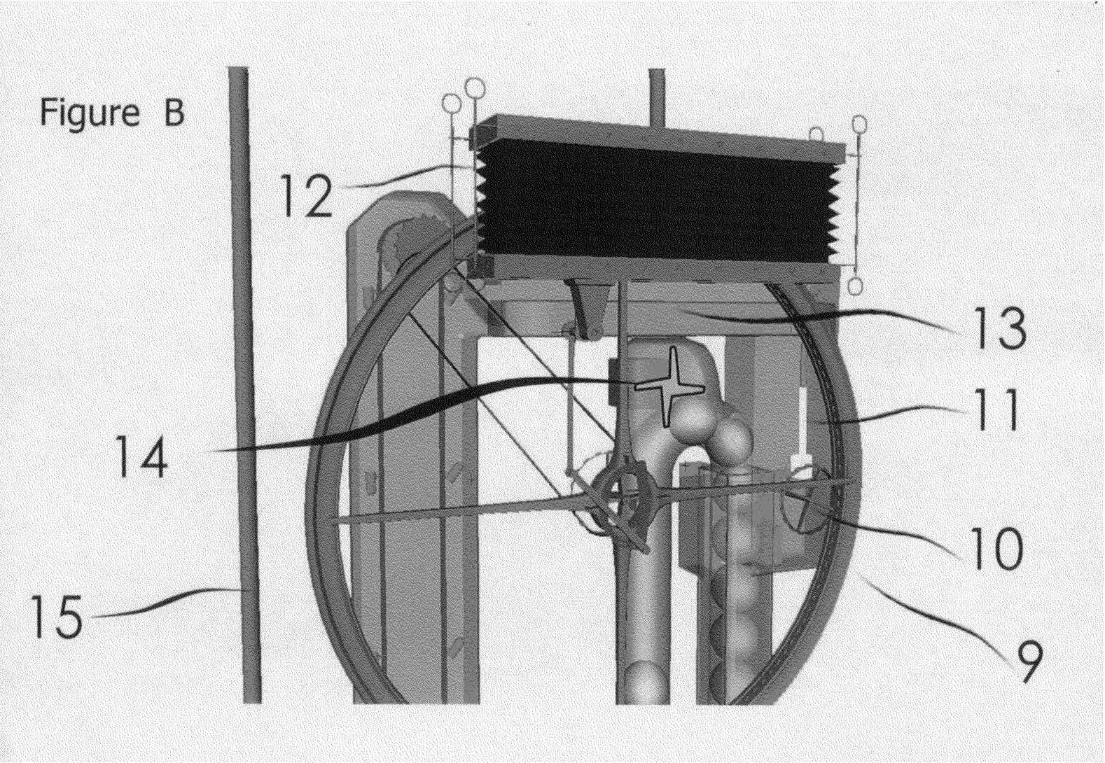

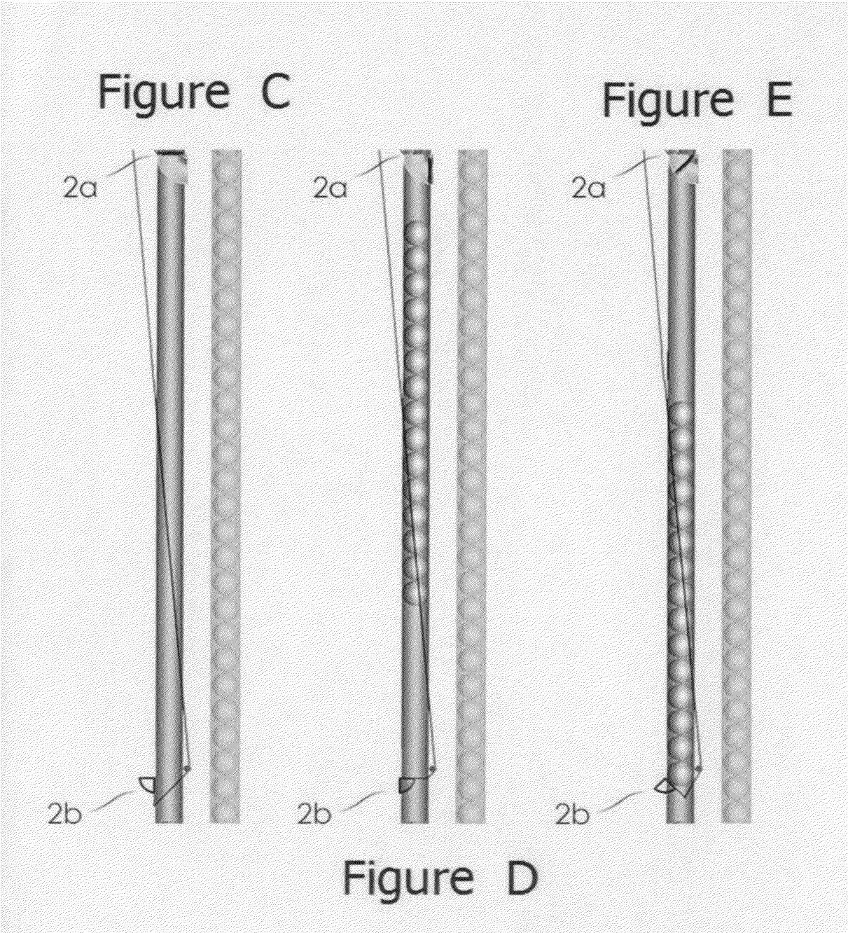

### BACKGROUND

The application of natural forces to produce motion applied to a generator or other usable work is a well proven concept, be it wind, tidal or hydroelectric. The concept described here follows these examples by applying natural forces to produce motion which can then generate power or be applied to usable work. Buoyancy and gravity do not naturally co-exist in a usable manor and any attempt to link them requires that the force generated exceed the parasitic power need to overcome the barriers to such a usable linkage.

In the 3^{RD} century B.C., Archimedes put forth the principle that an object immersed in water or liquid would be buoyed upward by a force equal to the fluid displaced. The Archimedes principle also allows that the lower the density of an object the greater the upward force, as such an object could exert an upward force greater than it's own weight.

It is not the intent of this mechanism to create force or power from nothing, rather it is the intent of this mechanism to utilize a force generally ignored, except for our constant efforts to overcome it's effects. The force is gravity, and in the absence of gravity this mechanism would fail to work.

### GENERAL DESCRIPTION

The introduction of buoyant objects into a liquid environment at a point below the surface is not a new concept, in fact the practice goes back hundreds of years. Another fact that is well known is that buoyant objects can exert a great deal of force in their attempt to rise to the surface. Just think of the effort required to hold even a small air filled ball underwater.

What is new is the method by which the upward buoyant force is greater than the energy required for the buoyant object to enter the liquid at a point below the surface of the liquid and the ability to repeat this action over and over.

It is a well established fact that in order to introduce an object into a liquid environment, at a point below the surface, from an area of normal air pressure a pressurized transfer area must be created with valves or airtight doors at either end. An object would enter through the open top valve into the transfer area which at this point is at normal air pressure. Once the top valve closes the air pressure in the transfer area must increase to a point where it is equal to the liquid's pressure at the level of the bottom valve. Once the pressure is equal the bottom valve will open and the objects enter the liquid. However, if the pressure is not equal liquid will rush in once the bottom valve opens.

What is difficult is that as the object(s) leave the sealed pressurized area an amount of air equal in volume to the object(s) must be added or the pressure will drop and the liquid level will rise. Once the object(s) have exited the lower valve will close and the process is ready to begin again.

Under perfect conditions the required to go up is equal to the force coming down. It is also true that conditions are never perfect and in fact, for the conditions here, valves require energy to overcome the friction of their seals when opening and closing. Add to that the energy required to raise and maintain the pressure in the transfer area and the result is that a far greater amount of energy is required to submerge an object than the objects buoyant force can generate. At least that is the current line of thought.

Liquid or water pressure is the result of gravity and it is possible to disperse that pressure over a greater area so that the water pressure at the point of entry is, for example, 10% of what it would be without dissipation. This is important because the lower the water pressure at the point where the buoyant objects enter the water the lower the energy required to raise the air pressure to match the water pressure. That helps to get closer to equalizing the equation but those valves still require a great deal of energy to function. The problem is friction and the solution was to develop unique valves that are designed in such a way that the valve door can move into position without friction from the valve seals. Once the valve door is in place it is then pulled or pushed tight against the seal. As a result the buoyant force now exceeds the submerging force in defiance of conventional wisdom.

### DETAILED DESCRIPTION

Power is cut temporarily to the electric magnets holding the door of the upper valve (2a) closed. The combined weight of the 15 balls in the Collection column (1) will then push the valve open and fall into the Pressure column (3). At a distance great enough to ensure that all the balls are within the Pressure column (3) the lead ball will strike a lever (2b) that will pull the valve door closed. At this point the valve (7) at the bottom of the Buoyancy column (8) will open, ball will then can enter the Buoyancy column (8). It requires the weight of 8 balls to be able to submerge one ball and as each ball exit's the Pressure column (3) an amount of air equal in volume to the balls exiting and at the same rate as the balls exit must be added in order to maintain a constant pressure to prevent water from rising in the Pressure column (3).

At the same rate balls enter at the bottom of the Buoyancy column (8) balls exit at the top of the column and then fall into the Collection column (1). As the balls are pushed upward and out of the Buoyancy column (8) by the collective force of all the buoyant balls they turn a paddle wheel (10) which can be used to generate power as well as powering the air bellows (12) and water lift system (16) by way of the Leverage wheel (9) which is utilized to increase torque to these systems.

Reducing the water pressure at the point where the balls enter the water at the bottom of the Pressure column (3) is critical to the designed objected of this concept. With in the Buoyancy column (8) we have a nearly fixed amount of water, for our purposes here we will assume the weight of the water to be 100 pounds and the base of the column to be 12.5 square inches. Which means the water pressure at both the bottom of both the Buoyancy and Pressure column (3) is 8 pounds per square inch, in addition to the normal air pressure of 14.7 pounds per square inch. The Dissipation area (6) below both columns is sealed and while the weight of the water in the buoyancy column (8) is fixed the are that weight is spread over can be enlarged to say 10 times the original 12.5 square inches. The same 100 pounds of water is now spread over an are of 125 square inches and reducing the water pressure at the point of enter to 10% of what the pressure would be without dissipation.

While dissipation has dramatic positive results, the same factors work just as effectively in a negative manor should an attempt be made to force any excess water from the Pressure column (3) and back up the Buoyancy column (8). The excess water might only weigh a few ounces but in order to make room for it at the bottom of the Buoyancy column (8) the full 100 pounds of water weight must be lifted.

The best coarse of action is therefore to allow the excess water in the Pressure column (3) to exit, when the column is at normal air pressure, via the Overflow valve (4) located at the desired water level point near the bottom of the Pressure column (3). The water will collect in the Overflow tank (5) and then be lifted (16) up the side of the machine to the refill tank (13) located above the Buoyancy column (8). From there the water will be reintroduced back into the Buoyancy column (8) at the top with the flow being metered by a float valve (11).

With this method only a few ounces are lifted instead of 100 pounds of water weight. The water being lifted (16) from the Overflow tank (5) at the bottom to the Refill tank (13) at the top may require several cycles to complete the journey. Timing and sequencing also play a critical role in the operation of the machine. The Brake (14) located between the Buoyancy column (8) and the Collection column (1) must open fractionally prior to the Bottom valve (7) opening. This will allow the balls in the Buoyancy column (8) to begin to rise and turn the Paddle wheel (10) which will turn the Leverage wheel (9) which will begin to close the Air Bellows (12) and increase the air pressure in the Pressure column (3) via the Air hose (15) which will limit the amount the water level will rise in the Pressure column (3).

The rate at which air enters the Pressure Column (3) is regulated by a combination of the dimensions of the Air Bellows (12) and the rate the Air Bellows (12) are closed. The Air Bellows (12) closing speed is controlled by the balls turning the Paddle Wheel (10) at the same rate balls exit the Pressure column (3). The Air Bellows (12) will begin to open before the Bottom valve (7) is closed and this would cause the air pressure in the Pressure column (3) to decrease if it were not for the Bellows valve (17). It is beneficial for the Air Bellows (12) to pump air into the Pressure column (3) as fast as possible and a rate faster than is needed to maintain air pressure. Such a variable rate can be achieved by the dimensions of the Air Bellows (3).

What has just been described is a carefully choreographed sequence of movement and tasks and the central focus of that choreography is that a specific number of buoyant objects, 15 buoyant objects in the example given here, move or are prevented from moving past certain locations at certain times in relation to other tasks being performed by various mechanisms of the device. Controlling this movement are mechanisms to count the number of buoyant objects passing their location. These counters control brakes and if desire the Paddle wheel (10). One of these Brake/Counters (18) is located between the upper valve (2) and the Lower Valve (7). At least one other Brake/Counter (14) is located between the Buoyancy column (8) and the Collection column (1). The Paddle wheel (10) may act alone as the counter and brake however in the example here a second Brake/Counter (14) is provided to further ensure the accurate movement of the buoyant objects through the device.

The cycle of the device described here has a period when it is generating force and a period when force is not being generated as measure by the Paddle wheel (10). As there are tasks that must be performed during the period when the Paddle wheel (10) is not harvesting force an alternative source of energy is needed. That energy source can be, but is not limited to a battery, batteries or other energy storage means, other devices or the general power grid.

In the brief period between cycles everything will reset so that the following cycle is the same as the previous cycle and thereby there is no performance degradation over time.

### DESCRIPTION OF DRAWING

### Figure A and Figure B

1. Collection Column

The area between the Buoyancy column and the Pressure column where the buoyant objects collect waiting for the Upper valve to open.

2. Upper Valve

The air tight seal between the Collection column and the Pressure column.

3. Pressure Column

Transfer area for the buoyant objects between normal air pressure and the liquid pressure at the bottom of the Buoyancy column

4. Overflow Valve/Depressurization Valve

Opens just prior to Upper valve to reduce air pressure. Allows excess liquid in Pressure column to flow into Overflow tank

5. Overflow Tank

Where the excess water from the Pressure column collects until it can be lifted to the Refill tank

6. Liquid Pressure Dissipation

The sealed area that acts to lower the liquid or water pressure at the point where the buoyant objects enter the liquid

7. Bottom Valve

When the Pressure column is at normal air pressure the Bottom valve must be closed to prevent the liquid from the Buoyancy column flowing into the Pressure column.

8. Buoyancy Column

Liquid filled area used to create buoyant force.

9. Leverage Wheel

Increases force to power one or more mechanisms.

10. Paddle Wheel/Counter

Harnesses the combined force of the buoyant objects in the Buoyancy column. Can also be used to regulate movement of buoyant objects.

11. Refill Float Valve Measures liquid level of Buoyancy column and adds liquid from Refill tank when needed.

12. Air Bellows

Utilized to increase air pressure in the Pressure column

13. Refill Tank

Where excess liquid from the Overflow tank is stored until needed as measured by the float valve.

14. Brake/Counter

Regulates the movement of buoyant objects from Buoyancy column to Collection column.

15. Air Hose

Allows air to pass from Bellows to pressurized area.

16. Liquid Lift

Carries liquid from the Overflow tank to the Refill tank.

17. Bellows Valve

Maintains pressurized area in period between when Bellows begin to open and Bottom valve is closed and sealed.

18. Brake/Counter

Regulates the movement of buoyant objects from Pressure column to Buoyancy column. By preventing buoyant objects from pressing against bottom valve less force is required to open and close valve door.

### Figure C

In the instant before the valve door (2a) opens, the valve lever (2b) is open.

### Figure D

In the instant after the valve door (2a) has opened and the falling buoyant objects have not yet reached the valve lever (2b). The action of the valve door (2a) opening downward has pulled the valve lever (2b), via a pulley, into the path of the falling buoyant objects.

### Figure E

As the lead buoyant object strikes the valve lever (2b) it pushes the valve lever (2b) down and out of the path of the buoyant objects. As the valve lever (2b) is pushed downward it pulls the valve door (2a), via a pulley, closed.

I claim:

1. A device which utilizes buoyancy and that draws all or a majority of the energy required to make it function from gravity and is able to convert more of that energy into usable force than is required to operate the device.

2. The device of claim 1 that utilizes one or more columns of buoyant objects, one or more mechanisms to count and regulate movement of the buoyant objects, valves to control pressure and to allow objects to enter and exit a pressurized area, a mechanism to pressurize said area and an apparatus to remove excess liquid at or near the bottom of the device and deliver it to at or near the top of the device and reintroduce the liquid into the device at or near the top of the buoyancy area.

3. The device of claim 2 wherein a column or area of buoyancy is provided where buoyant objects can rise. The buoyant objects then pass a paddle wheel or mechanism designed to harness the cumulative force of the buoyant objects. After the buoyant objects pass the paddle wheel they enter a collection column or area to wait until they are able to enter the pressurized column or area. A valve will open to allow the buoyant objects to enter the pressure column. Once the buoyant objects are in the pressurized area the valve will close and the air pressure will increase. The combined weight of the buoyant objects will force the lowest buoyant objects into the liquid at the bottom of the column. after the buoyant objects have entered the liquid they will pass a second valve and enter the buoyancy column.

4. The device of claim 2 wherein leverage is utilized to provide force to mechanisms which may include but not be limited to bellows and the liquid lift and recover system.

5. The device of claim 2 wherein at least one mechanism is located between the upper valve and the lower valve which can count objects as they pass and has the ability to halt or allow the progress of objects either by itself or by signaling another mechanism.

6. The device of claim 2 wherein at least one mechanism is located at or near the top of the device which has the ability to halt or allow the progress of objects either by itself or by signal to another mechanism, one of which could be the paddle wheel that harnesses the buoyant force.

7. The device of claim 2 wherein two or more columns or areas may share common parts or mechanisms such as valves, bellows, dissipation area, brakes, counting devices, leverage, liquid management (lift, overflow tank, refill tank, float valve).

8. The device of claim 2 wherein the Pressure column or area which is sealed from other non-pressurized areas, need not be sealed from other pressure columns or areas.

9. The device of claim 2 wherein the device or it's mechanisms that require electrical power are connected to a battery, batteries or other energy storage mechanism.

10. The device of claim 2 wherein the device is connected to an electrical generator.

11. The device of claim 2 wherein the device draws power from an external source.

12. The device of claim 2 wherein the bellows are closed by a piston or piston like mechanism.

13. The device of claim 2 wherein the rate of the piston's vertical movement is greater during early portion of the bellows closing than is normal for a point traveling in a circular route.

14. The device of claim 2 wherein an overflow valve or mechanism located at or near the desired liquid level at or near the bottom of the pressurized area which allows excess liquid to exit the pressurized area and can be sealed and unsealed.

15. The device of claim 2 wherein a valve or other such mechanism is utilized to depressurize the pressurized area. The overflow valve may, but is not required to, act as the depressurize valve.

16. The device of claim 2 wherein the valve door leading into the bottom of the buoyancy area opens in such a way as to allow the pressure difference between the liquid in the buoyancy column and in the dissipation area to help unseal the valve when it is time to open.

17. The device of claim 2 wherein a mechanism exists to signal the various component mechanisms of the device when to begin or end their tasks either by timer or in relation to other mechanisms tasks.

18. The device of claim 2 wherein a valve allows the bellows to begin to open while the Bottom valve is still open and maintain a pressurized area.

19. The device of claim 2 wherein the pressurized area is pressurized at a variable rate.

20. The device of claim 2 wherein electric magnet(s) pull valve door tight against seal.

21. The device of claim 2 wherein buoyant force is utilized to supply at least a portion of the forced needed to operate valve.

22. The device of claim 2 wherein the weight and inertia of objects is utilized to supply at least a portion of the force needed to operate valve.

23. The device of claim 2 wherein the valve door is able to move in such a way as to help complete an airtight seal that differs from the primary movement of the valve opening and closing.

24. The device of claim 2 wherein an area is provided to dissipate liquid pressure.

25. The device of claim 2 wherein a valve separates the pressurized area from the bellows or mechanism used to pressurize the pressurized area.

26. The device of claim 2 wherein a mechanism, measures the liquid level of the buoyancy area and is able to add liquid when needed.

27. The device of claim 2 wherein a valve includes but is not limited to a hinged valve door, a pulley and a lever.
